(19) United States
(12) Patent Application Publication
(10) Pub. No.: US 2005/0266989 A1
(43) Pub. Date: Dec. 1, 2005

(54) Desulfurization and novel sorbent for the same

(76) Inventors: Glenn W. Dodwell, Bartlesville, OK (US); Gyanesh P. Khare, Kingwood, TX (US); Donald R. Engelbert, Copan, OK (US); Charles E. Keith, Bartlesville, OK (US); Bobby G. Cockrell, Bartlesville, OK (US)

Correspondence Address: CONOCOPHILLIPS COMPANY - I.P. LEGAL, P.O. Box 2443, Bartlesville, OK, 74005, US

(21) Appl. No.: 10/994,936

(22) Filed: Nov. 22, 2004

Related U.S. Application Data
(62) Division of application No. 10/170,953, filed on Jun. 13, 2002.

(51) Int. Cl. B01J 20/08

(52) U.S. Cl. 502/415

(57) ABSTRACT

The attrition resistance of sorbent compositions are enhanced by controlling the pH of the support mixture containing the initial ingredients of the sorbent support. Desulfurization of a sulfur-containing fluid, such as cracked gasoline or diesel fuel, is enhanced by employing a co-feed gas comprising from about 80 to about 97 volume percent hydrogen.

### BACKGROUND OF THE INVENTION

This invention relates to a process of making a sorbent composition, a sorbent composition made by such process, and a process of using a sorbent composition for the removal of sulfur from a sulfur-containing fluid.

Hydrocarbon-containing fluids such as gasoline and diesel fuels typically contain a quantity of sulfur. High levels of sulfur in such automotive fuels is undesirable because oxides of sulfur present in automotive exhaust may irreversibly poison noble metal catalysts employed in automobile catalytic converters. Emissions from such poisoned catalytic converters may contain high levels of non-combusted hydrocarbons, oxides of nitrogen, and/or carbon monoxide, which, when catalyzed by sunlight, form ground level ozone, more commonly referred to as smog.

Much of the sulfur present in the final blend of most gasolines originates from a gasoline blending component commonly known as “cracked-gasoline.” Thus, reduction of sulfur levels in cracked-gasoline will inherently serve to reduce sulfur levels in most gasolines, such as, automobile gasolines, racing gasolines, aviation gasolines, boat gasolines, and the like.

Many conventional processes exist for removing sulfur from cracked-gasoline. However, most conventional sulfur removal processes, such as hydrodesulfurization, tend to saturate olefins and aromatics in the cracked-gasoline and thereby reduce its octane number (both research and motor octane number). Thus, there is a need for a process wherein desulfurization of cracked-gasoline is achieved while the octane number is maintained.

In addition to the need for removing sulfur from cracked-gasoline, there is also a need to reduce the sulfur content in diesel fuel. In removing sulfur from diesel fuel by hydrodesulfurization, the cetane is improved but there is a large cost in hydrogen consumption. Such hydrogen is consumed by both hydrodesulfurization and aromatic hydrogenation reactions. Thus, there is a need for a process wherein desulfurization of diesel fuel is achieved without significant consumption of hydrogen so as to provide a more economical desulfurization process.

Traditionally, sorbent compositions used in processes for removing sulfur from sulfur-containing fluids, such as cracked-gasoline and diesel fuel, have been agglomerates utilized in fixed bed applications. Because fluidized bed reactors have advantages over fixed bed reactors, such as better heat transfer and better pressure drop, sulfur-containing fluids are sometimes processed in fluidized bed reactors. Fluidized bed reactors generally use reactants (e.g., sorbent compositions) that are in the form of relatively small particulates. The size of these particulates is generally in a range of from about 1 micron to about 10 millimeters. However, conventional reactant particulates generally do not have sufficient attrition resistance (i.e., resistance to physical deterioration) for all applications. Consequently, finding a sorbent with sufficient attrition resistance that removes sulfur from these sulfur-containing fluids and that can be used in fluidized, transport, moving, or fixed bed reactors is desirable and would be a significant contribution to the art and to the economy.

When sulfur-removing sorbents are employed in fluidized bed reactors to remove sulfur from normally liquid fluids, such as cracked gasoline or diesel fuel, it is typically necessary to employ a hydrogen-containing co-feed gas to aid in vaporizing the normally liquid sulfur-containing fluids, to provide a source of hydrogen for the hydrogen-consuming reactions taking place in the reactor, and/or to aid in “lifting” (i.e., fluidizing) the sorbent particles in the reactor so that proper contacting of the sorbent particles and sulfur-containing gas is maintained. Such co-feed gas can, however, have an adverse impact on desulfurization performance if the composition of the co-feed gas is not amenable to the desulfurization reactions or if the co-feed gas causes undesirable side reactions (such as saturation of olefins) in the desulfurization zone. Consequently, finding a hydrogen-containing co-feed gas that is amenable to the desulfurization reactions and does not cause deactivation of the sorbent would be a significant contribution to the art and the economy.

### SUMMARY OF THE INVENTION

Accordingly, it is an object of the present invention to provide a novel method of making a sorbent composition which is suitable for removing sulfur from sulfur-containing fluids, such as cracked-gasoline and diesel fuels, and has enhanced attrition resistance.

A further object of this invention is to provide a sorbent composition made by a novel process which enhances the attrition resistance of the resulting sorbent composition.

Another object of this invention is to provide a process for the removal of sulfur from sulfur-containing fluid streams which minimizes saturation of olefins and aromatics therein.

A still further object of this invention is to provide a process for the removal of sulfur from sulfur-containing fluid streams which minimizes deactivation of the sorbent composition.

A yet further object of this invention is to provide a process for the removal of sulfur from sulfur-containing fluid streams which minimizes hydrogen consumption.

It should be noted that the above-listed objects need not all be accomplished by the invention claimed herein and other objects and advantages of this invention will be apparent from the following description of the preferred embodiments and appended claims.

Accordingly, in one embodiment of the present invention, a process for making a sorbent composition is provided. The process comprises the steps of: (a) admixing a zinc source and an aluminum source to provide a support mixture; (b) controlling the pH of the support mixture in a range of from about 5.0 to about 7.0; and (c) incorporating a promoter metal with the support mixture to provide a promoted sorbent.

In another embodiment of the present invention, a process for making a sorbent composition is provided. The process comprises the steps of: (a) admixing a zinc source, an aluminum source, and an acid to provide a support mixture, wherein the acid is present in the support mixture in an amount sufficient to maintain the pH of the support mixture in a range of from about 5.0 to about 7.0; (b) shaping the support mixture into support particulates; (c) calcining the support particulates to provide calcined support particulates comprising a zinc aluminate component; (d) incorporating a promoter metal with the calcined support particulates to provide a promoted sorbent; (e) calcining the promoted sorbent to provide a calcined promoted sorbent; and (f) reducing the calcined promoted sorbent to thereby provide a reduced sorbent.

In another embodiment of the present invention, there is provided a desulfurization process comprising the steps of: (a) charging a sulfur-containing fluid and a hydrogen-containing co-feed gas to a desulfurization zone, wherein the co-feed gas comprises from about 80 to about 97 volume percent hydrogen; (b) contacting the sulfur-containing fluid and the co-feed gas with a sorbent comprising a promoter metal and zinc oxide in the desulfurization zone under desulfurization conditions sufficient to reduce the amount of the sulfur in the sulfur-containing fluid and provide a sulfided sorbent comprising zinc sulfide; (c) contacting at least a portion of the sulfided sorbent with an oxygen-containing regeneration stream in a regeneration zone under regeneration conditions sufficient to convert at least a portion of the zinc sulfide to zinc oxide, thereby providing a regenerated sorbent; (d) contacting at least a portion of the regenerated sorbent with a reducing stream in an activation zone under activation conditions sufficient to reduce at least a portion of the promoter metal, thereby providing an activated sorbent; and (e) returning at least a portion of the activated sorbent to the desulfurization zone.

### BRIEF DESCRIPTION OF THE DRAWINGS

FIG. 1 is a graphic plotting the amount of sulfur in the gasoline effluent of a desulfurization reactor as a function of time on stream, with the composition of the co-feed gas being changed at certain times on stream.

### DETAILED DESCRIPTION OF THE PREFERRED EMBODIMENTS

In accordance with a first embodiment of the present invention, a novel process for making a sorbent composition is provided. The process generally comprises the steps of: (a) combining support components including a zinc source, an aluminum source, an acid, a solvent, and, optionally, a filler and/or a porosity enhancer; (b) mixing the support components to provide a substantially homogeneous support mixture in the form of a slurry; (c) controlling the pH of the support mixture in the range of from about 5.0 to about 7.0 by controlling the amount of acid in the support mixture; (d) shaping the support mixture into support particulates by spray drying the support mixture into microspherical particles; (e) calcining the support particulates to thereby provide calcined support particulates having a zinc aluminate component formed from at least a portion of the zinc source and at least a portion of the aluminum source; (f) incorporating a promoter metal with the calcined support particulates by impregnation with an aqueous solution containing the promoter metal, thereby providing a promoted sorbent; (g) calcining the promoted sorbent to thereby provide a calcined promoted sorbent having a substitutional solid metal oxide solution component characterized by the following formula: M_{X}Zn_{Y}O, wherein M is the promoter metal, X is a numerical value in the range of from about 0.5 to about 0.9, and Y is a numerical value in a range of from about 0.1 to about 0.5; (h) reducing the calcined promoted sorbent to thereby provide a reduced sorbent having a substitutional solid metal solution component characterized by the following formula: M_{A}Zn_{B}, wherein M is the promoter metal, A is a numerical value in a range of from about 0.50 to about 0.99, and B is a numerical value in a range of from about 0.01 to about 0.50.

The zinc source employed in step (a), described above, can be any zinc-containing compound. Preferably, the zinc source is in the form of zinc oxide or one or more zinc compounds that are convertible to zinc oxide. Most preferably, the zinc source is in the form of a powdered zinc oxide. The zinc source, preferably powdered zinc oxide, will generally be present in the support mixture in an amount in the range of from about 2 to about 50 weight percent based on a total weight of the support mixture, more preferably in the range of from about 5 to about 30 weight percent, and most preferably in the range of from 10 to 20 weight percent.

The aluminum source employed in step (a), described above, can be any aluminum-containing compound. The aluminum source can be any suitable commercially available alumina material including, but not limited to, colloidal alumina solutions, hydrated aluminas, peptized aluminas, and, generally, those alumina compounds produced by the dehydration of alumina hydrates. The preferred alumina source is a hydrated alumina such as, for example, boehmite or pseudoboehmite. The aluminum source, preferably a hydrated alumina, will generally be present in the support mixture in an amount such that the weight ratio of the zinc source to the aluminum source in the support mixture is in the range of from about 1:1 to about 20:1, more preferably in the range of from about 2:1 to about 10:1, and most preferably in the range of from 3:1 to 5:1.

The acid employed in step (a), described above, can be any acidic compound, preferably in a liquid state, operable to control the pH of the support mixture within the desired range. The amount of acid added to the support mixture can be any amount suitable for controlling the pH of the support mixture in the range of from about 5.0 to about 7.0, more preferably in the range of from about 5.5 to about 6.5, and most preferably in the range of from 5.7 to 6.0. It has been discovered that such controlling of the support mixture pH during sorbent preparation results in a final sorbent composition having enhanced attrition resistance. Preferably, the acid employed in step (a) is a concentrated nitric acid (i.e., 70% HNO₃). The amount of acid employed in the support mixture is preferably an amount which provides a weight ratio of the zinc source to acid in the range of from about 0.5:1 to about 10:1, more preferably in the range of from about 1:1 to about 5:1, and most preferably in the range of from 1.5:1 to 3:1.

The solvent employed in step (a), described above, can be any liquid added to the support mixture to help form a support mixture having an optimum consistency for shaping, preferably by spray drying. The most preferred solvent is distilled water. The solvent, preferably distilled water, should be present in the support mixture in an amount such that the weight ratio of the zinc source to the solvent is in the range of from about 0.05:1 to about 2:1, and most preferably in the range of from 0.1:1 to 1:1.

When a filler is employed in step (a), described above, the filler can be any compound which enhances the ability of the support mixture to be spray dried. Preferably, the filler is a clay such as, for example, kaolin clay. When the support mixture includes a filler, preferably kaolin clay, the filler should be present in the support mixture in an amount which provides a weight ratio of the zinc source to the filler in the range of from about 0.1:1 to about 5:1, more preferably in the range of from about 0.2:1 to 3:1, and most preferably in the range of from 0.5:1 to 2:1.

When a porosity enhancer is employed in step (a), described above, the porosity enhancer can be any compound which ultimately increases the macroporosity of the resulting calcined support particulates formed from the support mixture. Preferably, the porosity enhancer is perlite. The term “perlite” as used herein is the petrographic term for a siliceous volcanic rock which naturally occurs in certain regions throughout the world. The distinguishing feature, which sets it apart from other volcanic minerals, is its ability to expand four to twenty times its original volume when heated to certain temperatures. When heated above 1600° F., crushed perlite expands due to the presence of combined water which is containd within the crude perlite rock. The combined water vaporizes during the heating process and creates countless tiny bubbles in the heat softened glassy particles. It is these diminutive glass sealed bubbles which account for its light weight. Expanded perlite can be manufactured to weigh as little as 2.5 lbs per cubic foot. Typical chemical analysis properties of expanded perlite are: silicon dioxide 73%, aluminum oxide 17%, potassium oxide 5%, sodium oxide 3%, calcium oxide 1%, plus trace elements. Typical physical properties of expanded perlite are: softening point 1600-2000° F., fusion point 2300° F.-2450° F., pH 6.6-6.8, and specific gravity 2.2-2.4. The term “expanded perlite” as used herein refers to the spherical form of perlite which has been expanded by heating the perlite siliceous volcanic rock to a temperature above 1600° F. The term “particulate expanded perlite” or “milled perlite” as used herein denotes that form of expanded perlite which has been subjected to crushing so as to form a particulate mass wherein the particle size of such mass is comprised of at least 97% of particles having a size of less than 2 microns. The term “milled expanded perlite” is intended to mean the product resulting from subjecting expanded perlite particles to milling or crushing. The porosity enhancer, preferably expanded perlite, should be present in the support mixture in an amount such that the weight ratio of the zinc source to the porosity enhancer is in the range of from about 1:1 to about 30:1, more preferably in the range of from 2:1 to about 15:1, and most preferably in the range of from 3:1 to 8:1.

The support components are generally combined and mixed by any suitable method or manner which provides for the intimate mixing of such components to thereby provide a substantially homogeneous mixture of the support components. Any suitable means for mixing the support components can be used to achieve the desired dispersion of such components. Examples of suitable mixing means include, but are not limited to, mixing tumblers, stationery shells or troughs. Muller mixers, which are of the batch or continuous type, impact mixers, and the like. It is presently preferred to use a Muller mixer in the mixing of the support components.

The support components are admixed to provide a resulting support mixture which can be in the form selected from the group consisting of a wet mix, a dough, a paste, a slurry, and the like. Such resulting support mixture can then be shaped to form a particulate(s) selected from the group consisting of a granulate, an extrudate, a tablet, a sphere, a pellet, a microsphere, and the like. Preferably, the resulting support mixture is in the form of a slurry, and the shaping of the slurry into particulates is achieved by spray drying the slurry to form microspheres having a mean particle size generally in the range of from about 1 micron to about 500 microns, preferably in the range of from about 10 microns to about 300 microns. Spray drying is known in the art and is discussed in Perry's Chemical Engineers Handbook, 6th Edition, published by McGraw-Hill, Inc. at pages 20-58. Additional information can be obtained from the Handbook of Industrial Drying, published by Marcel Dekker, Inc. at pages 243- 293.

After shaping, preferably spray drying, the support particulates are preferably dried and calcined. Any drying method(s) known to one skilled in the art such as, for example, air drying, heat drying, vacuum drying, and the like and combinations thereof, can be used. Preferably, the sorbent particulates are dried at a temperature in the range of from about 180° F. to about 290° F., more preferably in the range of from 200° F. to 270° F. The pressure employed during drying of the support particulates can be in the range of from about atmospheric (i.e., 14.7 pounds per square inch absolute) to about 150 pounds per square inch absolute (psia), more preferably in the range of from about atmospheric to about 100 psia, and most preferably about atmospheric, so long as the desired temperature can be maintained. Any suitable period for drying the support particulates can be employed. Preferably, the drying of the support particulates takes place during a time period in the range of from about 0.5 hour to about 60 hours, more preferably in the range of from 1.5 hours to 20 hours.

The calcining of the dried support particulates can be performed at a calcination temperature in the range of from about 400° F. to about 1800° F., more preferably in the range of from about 600° F. to about 1600° F., and most preferably in the range of from 800° F. to 1500° F. The calcination pressure is preferably in the range of from about 7 psia to about 750 psia, more preferably in the range of from about 7 psia to about 450 psia, and most preferably in the range of from 7 psia to 150 psia. The time period for the calcination of the dried support particulates is generally in the range of from about 1 hour to about 60 hours, more preferably in the range of from about 2 hours to about 20 hours, and most preferably in the range of from 3 hours to 15 hours.

During calcination of the support particulates, at least a portion of the zinc source and at least of portion of the aluminum source chemically combine to form zinc aluminate (ZnAl₂O₄). The calcined support particulates preferably comprise zinc aluminate in an amount in the range of from about 2 to about 40 weight percent based on the total weight of the calcined support particulates, more preferably in the range of from about 5 to about 30 weight percent, and most preferably in the range of from 10 to 20 weight percent. The calcined support particulates preferably comprise zinc oxide in an amount in the range of from about 20 to about 95 weight percent, more preferably in the range of from about 40 to about 85 weight percent, and most preferably in the range of from 60 to 80 weight percent.

The resulting calcined support particulates can then be contacted with a promoter metal source to thereby incorporate the promoter metal with the calcined support particulates. The promoter metal can be at least one metal selected from the group consisting of nickel, cobalt, iron, manganese, tungsten, silver, gold, copper, platinum, zinc, tin, ruthenium, molybdenum, antimony, vanadium, iridium, chromium, palladium, and rhodium. Most preferably, the promoter metal is nickel. The promoter metal may be incorporated on, in, or with the calcined support particulates by any suitable means or method known in the art such as, for example, impregnating, soaking, spraying, and combinations thereof. The preferred method of incorporating the promoter metal with the calcined support particulates is impregnating using standard incipient wetness impregnation techniques. A preferred impregnation method employs an impregnation solution comprising the desired concentration of the promoter metal so as to ultimately provide a promoted sorbent comprising the desired quantity of the promoter metal. The impregnation solution can be an aqueous solution formed by dissolving the promoter metal source in a solvent, preferably water. It is acceptable to use somewhat of an acidic solution to aid in the dissolution of the promoter metal source. It is most preferred for the calcined support particulates to be impregnated with the promoter metal by using a solution containing nickel nitrate hexahydrate dissolved in water.

Generally, the amount of the promoter metal incorporated, preferably impregnated, onto, into or with the calcined support particulates, is an amount which provides, after the promoted sorbent particulate material has been dried and calcined, a promoted sorbent composition comprising the promoter metal in an amount in the range of from about 1 to about 60 weight percent promoter metal based on the total weight of the promoted sorbent, preferably an amount in the range of from about 5 to about 50 weight percent promoter metal, and most preferably in an amount in the range of from 10 to 40 weight percent promoter metal. It may be necessary to employ one or more incorporation steps in order to incorporate the desired quantity of the promoter metal with the calcined support particulates. If so, such additional incorporation(s) are performed in substantially the same manner as described above.

Once the promoter metal has been incorporated on, in, or with the calcined support particulates, the promoted sorbent particulates are then dried and calcined. The drying and calcining of the promoted sorbent particulates can be accomplished by any suitable method(s) known in the art. Preferably, the drying and calcining of the promoted sorbent particulates is performed in substantially the same manner and under substantially the same conditions as previously described with reference to the drying and calcining of the unpromoted support particulates.

When the promoted sorbent particulates are calcined, at least a portion of the promoter metal and at least a portion of the zinc oxide present in the promoted sorbent chemically combine to form a substitutional solid metal oxide solution characterized by the formula: M_{X}Zn_{Y}O, wherein M is the promoter metal, X is a numerical value in the range of from about 0.5 to about 0.9, and Y is a numerical value in the range of from about 0.1 to about 0.5. In the above formula, it is preferred for X to be in the range of from about 0.6 to about 0.8 and most preferably from 0.65 to 0.75. It is further preferred for Y to be in the range of from about 0.2 to about 0.4, and most preferably from 0.25 to 0.35. Preferably, Y is equal to (1−X). The calcined, promoted sorbent particulates preferably comprise the substitutional solid metal oxide solution (M_{X}Zn_{Y}O) in an amount in the range of from about 5 to about 70 weight percent, more preferably in the range of from about 10 to about 60 weight percent, and most preferably in the range of from 20 to 40 weight percent.

Substitutional solid solutions have unique physical and chemical properties that are important to the chemistry of the sorbent composition described herein. Substitutional solid solutions are a subset of alloys that are formed by the direct substitution of the solute metal for the solvent metal atoms in the crystal structure. For example, it is believed that the substitutional solid metal oxide solution (M_{X}Zn_{Y}O) found in the oxidized (i.e., unreduced), calcined sorbent composition made by the process of the present invention is formed by the solute zinc metal atoms substituting for the solvent promoter metal atoms. There are three basic criteria that favor the formation of substitutional solid solutions: (1) the atomic radii of the two elements are within 15 percent of each other; (2) the crystal structures of the two pure phases are the same; and (3) the electronegativities of the two components are similar. The promoter metal (as the elemental metal or metal oxide) and zinc oxide employed in the inventive sorbent composition preferably meet at least two of the three criteria set forth above. For example, when the promoter metal is nickel, the first and third criteria, are met, but the second is not. The nickel and zinc metal atomic radii are within 10 percent of each other and the electronegativities are similar. However, nickel oxide (NiO) preferentially forms a cubic crystal structure, while zinc oxide (ZnO) prefers a hexagonal crystal structure. A nickel zinc oxide solid solution retains the cubic structure of the nickel oxide. Forcing the zinc oxide to reside in the cubic structure increases the energy of the phase, which limits the amount of zinc that can be dissolved in the nickel oxide structure. This stoichiometry control manifests itself microscopically in a 70:30 nickel zinc oxide solid solution (Ni_{0.7}Zn_{0.3}O) that is formed during oxidation (i.e., calcination or regeneration) and microscopically in the repeated regenerability of the sorbent.

During calcination of the promoted sorbent particulates, at least a portion of the promoter metal combines with at least a portion of the zinc aluminate to form a promoter metal-zinc aluminate substitutional solid solution characterized by the formula: M_{Z}Zn_{(1-Z)}Al₂O₄), wherein Z is a numerical value in the range of from 0.01 to 0.99. The calcined, promoted sorbent particulates preferably comprise the promoter metal-zinc aluminate substitutional solid solution in an amount in the range of from about 1 to about 50 weight percent, more preferably in the range of from about 2 to about 30 weight percent, and most preferably in the range of from about 4 to 20 weight percent.

The calcined, promoted sorbent particulates preferably comprise zinc oxide in an amount in the range of from about 5 to about 80 weight percent, more preferably in the range of from about 20 to about 60 weight percent, and most preferably in the range of from about 30 to 50 weight percent.

After calcination, the calcined, promoted sorbent particulates are thereafter subjected to reduction with a suitable reducing agent, preferably hydrogen, under reducing conditions, to thereby provide a reduced sorbent composition. Reduction can be carried out at a temperature in the range of from about 100° F. to about 1500° F. and a pressure in the range of from about 15 psia to about 1500 psia. Such reduction can be carried out for a time period sufficient to achieve the desired level of reduction, generally a time period in the range of from about 0.1 hour to about 20 hours.

During reduction of the calcined, promoted sorbent particulates, at least a portion of the substitutional solid metal oxide solution (M_{X}Zn_{Y}O) is preferably reduced to form a substitutional solid metal solution characterized by the formula: M_{A}Zn_{B}, wherein M is the promoter metal, A is a numerical value in the range of from about 0.50 to about 0.99, and B is a numerical value in the range of from about 0.01 to about 0.50. In the above formula for the substitutional solid metal solution, it is preferred for A to be in the range of from about 0.70 to about 0.97, more preferably in the range of from about 0.80 to about 0.95, and most preferably in the range of from about 0.90 to about 0.94. It is further preferred for B to be in the range of from about 0.03 to about 0.30, more preferably in the range of from about 0.05 to about 0.20, and most preferably in the range of from about 0.06 to 0.10. Preferably, B is equal to (1−A). The reduced sorbent particulates preferably comprise the substitutional solid metal solution (M_{A}Zn_{B}) in an amount in the range of from about 10 to about 80 weight percent, more preferably in the range of from about 20 to about 60 weight percent, and most preferably in the range of from about 30 to 40 weight percent.

The reduced sorbent particulates preferably comprise the promoter metal-inc aluminate substitutional solid solution (M_{Z}Zn_{(1-Z)}Al₂O₄), described above with reference to the unreduced, promoted support particulates, in an amount in the range of from about 1 to about 50 weight percent, more preferably in the range of from about 2 to about 30 weight percent, and most preferably in the range of from 4 to 20 weight percent.

The reduced sorbent particulates preferably comprise zinc oxide in an amount in the range of from about 5 to about 80 weight percent, more preferably in an amount in the range of from about 20 to about 60 weight percent, and most preferably in the range of from 30 to 50 weight percent.

When a porosity enhancer, preferably perlite, is employed in the making of the sorbent, the reduced sorbent particulates preferably comprise such porosity enhancer in an amount in the range of from about 2 to about 50 weight percent, more preferably in the range of from about 5 to about 30 weight percent, and most preferably in the range of from 10 to 20 weight percent.

In accordance with another embodiment of the present intention, a sorbent composition prepared in accordance with the above-described procedure, can be contacted with a sulfur-containing fluid in a desulfurization zone, to thereby form a desulfurized fluid and a sulfurized sorbent.

The sulfur-containing fluid employed in the desulfurization process of the present invention is preferably a hydrocarbon-containing fluid comprising a quantity of sulfur compounds therein. Preferably, such hydrocarbon-containing fluid can be used as a fuel or can be a precursor to fuel. Examples of suitable hydrocarbon-containing fluids include cracked-gasoline, diesel fuels, jet fuels, straight-run naphtha, straight-run distillates, coker gas oil, coker naphtha, alkylates, and straight-run gas oil. Most preferably, the sulfur-containing fluid comprises a hydrocarbon-containing fluid selected from the group consisting of gasoline, cracked-gasoline, diesel fuel, and mixtures thereof.

As used herein, the term “gasoline” denotes a mixture of hydrocarbons boiling in a range of from about 100° F. to about 400° F., or any fraction thereof. Examples of suitable gasolines include, but are not limited to, hydrocarbon streams in refineries such as naphtha, straight-run naphtha, coker naphtha, catalytic gasoline, visbreaker naphtha, alkylates, isomerate, reformate, and the like, and mixtures thereof.

As used herein, the term “cracked-gasoline” denotes a mixture of hydrocarbons boiling in a range of from about 100° F. to about 400° F., or any fraction thereof, that are products of either thermal or catalytic processes that crack larger hydrocarbon molecules into smaller molecules. Examples of suitable thermal processes include, but are not limited to, coking, thermal cracking, visbreaking, and the like, and combinations thereof. Examples of suitable catalytic cracking processes include, but are not limited to, fluid catalytic cracking, heavy oil cracking, and the like, and combinations thereof. Thus, examples of suitable cracked-gasolines include, but are not limited to, coker gasoline, thermally cracked gasoline, visbreaker gasoline, fluid catalytically cracked gasoline, heavy oil cracked-gasoline and the like, and combinations thereof. In some instances, the cracked-gasoline may be fractionated and/or hydrotreated prior to desulfurization when used as the sulfur-containing fluid in the process in the present invention.

As used herein, the term “diesel fuel” denotes a mixture of hydrocarbons boiling in a range of from about 300° F. to about 750° F., or any fraction thereof. Examples of suitable diesel fuels include, but are not limited to, light cycle oil, kerosene, jet fuel, straight-run diesel, hydrotreated diesel, and the like, and combinations thereof.

The sulfur-containing fluid described herein as suitable feed in the inventive desulfurization process comprises a quantity of olefins, aromatics, and sulfur, as well as paraffins and naphthenes. The amount of olefins in gaseous cracked-gasoline is generally in a range of from about 10 to about 35 weight percent olefins based on the total weight of the gaseous cracked-gasoline. For diesel fuel there is essentially no olefin content. The amount of aromatics in gaseous cracked-gasoline is generally in a range of from about 20 to about 40 weight percent aromatics based on the total weight of the gaseous cracked-gasoline. The amount of aromatics in gaseous diesel fuel is generally in a range of from about 10 to about 90 weight percent aromatics based on the total weight of the gaseous diesel fuel. The amount of atomic sulfur in the sulfur-containing fluid, preferably cracked-gasoline or diesel fuel, suitable for use in the inventive desulfurization process is generally greater than about 50 parts per million by weight (ppmw) of the sulfur-containing fluid, more preferably in a range of from about 100 ppmw atomic sulfur to about 10,000 ppmw atomic sulfur, and most preferably from 150 ppmw atomic sulfur to 500 ppmw atomic sulfur. It is preferred for at least about 50 weight percent of the atomic sulfur present in the sulfur-containing fluid employed in the present invention to be in the form of organosulfur compounds. More preferably, at least about 75 weight percent of the atomic sulfur present in the sulfur-containing fluid is in the form of organosulfur compounds, and most preferably at least 90 weight percent of the atomic sulfur is in the form of organosulfur compounds. As used herein, “sulfur” used in conjunction with “ppmw sulfur” or the term “atomic sulfur”, denotes the amount of atomic sulfur (about 32 atomic mass units) in the sulfur-containing fluid, not the atomic mass, or weight, of a sulfur compound, such as an organo-sulfur compound.

As used herein, the term “sulfur” denotes sulfur in any form normally present in a sulfur-containing fluid such as cracked-gasoline or diesel fuel. Examples of such sulfur which can be removed from a sulfur-containing fluid through the practice of the present invention include, but are not limited to, hydrogen sulfide, carbonal sulfide (COS), carbon disulfide (CS₂), mercaptans (RSH), organic sulfides (R—S—R), organic disulfides (R—S—S—R), thiophene, substitute thiophenes, organic trisulfides, organic tetrasulfides, benzothiophene, alkyl thiophenes, alkyl benzothiophenes, alkyl dibenzothiophenes, and the like, and combinations thereof, as well as heavier molecular weights of the same which are normally present in sulfur-containing fluids of the types contemplated for use in the desulfurization process of the present invention, wherein each R can by an alkyl, cycloalkyl, or aryl group containing 1 to 10 carbon atoms.

As used herein, the term “fluid” denotes gas, liquid, vapor, and combinations thereof.

As used herein, the term “gaseous” denotes the state in which the sulfur-containing fluid, such as cracked-gasoline or diesel fuel, is primarily in a gas or vapor phase.

The contacting of the sulfur-containing fluid and sorbent composition is carried out in a desulfurization zone of a reactor under a set of desulfurization conditions that include total pressure, temperature, and weighted hourly space velocity.

The desulfurization conditions at which the desulfurization zone is maintained preferably include a temperature in a range of from about 200° F. to about 1200° F., more preferably from about 500° F. to about 900° F., and most preferably from 600° F. to 800° F. for best sulfur removal.

The total pressure at which the desulfurization zone is maintained is preferably in a range of from about 15 pounds per square inch gauge (psig) to about 1500 psig, more preferably from about 50 psig to about 600 psig, and most preferably from 100 psig to 200 psig for best sulfur removal.

As used herein, the term “weighted hourly spaced velocity” or “WHSV” is defined as the numerical ratio of the rate at which the sulfur-containing fluid is charged to the desulfurization zone in pounds per hour at standard conditions of temperature and pressure (STP) divided by the pounds of the sorbent composition contained in the desulfurization zone to which the sulfur-containing fluid is charged. In the practice of the present invention, such WHSV should be in a range of about 0.5 hr⁻¹ to about 50 hr⁻¹, preferably in a range of from about 1 hr⁻¹ to about 20 hr⁻¹ for best sulfur removal. Desulfurization of the sulfur-containing fluid in the desulfurization zone should be conducted for a time sufficient to affect the removal of at least a substantial portion of the sulfur from such sulfur-containing fluid.

A hydrogen-containing co-feed gas is simultaneously charged to the desulfurization zone with the sulfur-containing fluid. The co-feed gas provides a source of hydrogen for the hydrogen-consuming reactions taking place in the desulfurization zone during desulfurization of the sulfur-containing fluid. The co-feed gas is preferably mixed with the sulfur-containing fluid prior to injection into the desulfurization zone. When the sulfur-containing fluid is a normally liquid fluid such as, for example, cracked gasoline or diesel fuel, the co-feed gas can aid in causing substantial vaporization of the sulfur-containing fluid in the desulfurization zone. Such vaporization of the sulfur-containing fluid in the desulfurization zone is especially important when the desulfurization zone is the reaction zone of a fluidized bed reactor.

It has been discovered that the specific composition of the hydrogen containing co-feed gas impacts the efficiency of sulfur removal in the desulfurization zone. When pure hydrogen is employed as the co-feed gas, excess hydrogenation of the sulfur-containing fluid can occur. Such excess hydrogenation can result in the highly undesirable loss of octane (both research and motor octane numbers) and olefins. However, when a co-feed gas comprising only a small proportion (e.g., less than 50% by volume) of hydrogen is employed, the sorbent can lose its desulfurization activity at an undesirably high rate. An optimum hydrogen concentration in the co-feed gas provides for effective desulfurization of the sulfur-containing gas without causing excessive sorbent deactivation or excessive octane loss. To achieve optimum desulfurization of the sulfur-containing fluid in the desulfurization zone, the co-feed gas preferably comprises from 80 to about 97 volume percent hydrogen, more preferably from about 85 to about 95 volume percent hydrogen, and most preferably from 88 to 92 volume percent hydrogen. The remaining (non-hydrogen) volume of the co-feed gas is preferably a gaseous diluent which is substantially inert to the desulfurization reactions taking place in the desulfurization zone. Preferably, such diluent is nitrogen. The co-feed gas preferably comprises from about 3 to about 20 volume percent of the diluent, more preferably from about 5 to about 15 volume percent of the diluent, and most preferably from 8 to 12 volume percent of the diluent.

The co-feed gas and desulfurization conditions employed in the desulfurization process of the present invention are preferably sufficient to provide vaporization of substantially all of the sulfur-containing fluid present in the desulfurization zone. Preferably, at least about 75 weight percent of the sulfur-containing fluid present in the desulfurization zone is in the vapor phase, more preferably at least about 95 weight percent of the sulfur-containing fluid is in the vapor phase, and most preferably at least 98 weight percent of the sulfur-containing fluid is in the vapor phase for best sulfur removal.

It is presently preferred that the desulfurization reaction of the present invention is carried out in the reaction zone of a fluidized bed reactor. As used herein, the term “fluidized bed reactor” denotes a reactor wherein a fluid feed can be contacted with solid particles (such as sorbent particles) in a manner such that the solid particles are at least partly suspended within the reaction zone by the flow of the fluid feed through the reaction zone and the solid particles are substantially free to move about within the reaction zone as driven by the flow of the fluid feed through the reaction zone. It is presently preferred, when the desulfurization zone is in a fluidized bed reactor system, that a sorbent composition be used having particle sizes within the range of from about micron to about 500 microns, preferably from about 10 microns to about 300 microns. Sated in other terms, it is presently preferred, when the desulfurization zone is in a fluidized bed reactor system, that a sorbent composition be used having a mean particle size in the range of from about 40 microns to about 120 microns, preferably from about 60 microns to about 0 microns.

When the sorbent composition is contacted with the sulfur-ontaining fluid in the desulfurization zone, sulfur compounds, particularly organosulfur compounds, present in the sulfur-containing fluid are removed from such fluid. At least a portion of the sulfur removed from the sulfur-containing fluid is employed to convert at least a portion of the zinc oxide of the sorbent composition into zinc sulfide. While not wishing to be bound by theory, it is believed that the promoter metal of the sorbent composition functions to facilitate removal of the sulfur from the sulfur-containing fluid while the zinc oxide functions to facilitate the storage of the sulfur on/in the sorbent composition through the conversion of at least a portion of the zinc oxide to zinc sulfide.

In contrast to many conventional sulfur removal processes (e.g., hydrodesulfurization), it is preferred that substantially none of the sulfur removed from the sulfur-containing fluid is converted to hydrogen sulfide. Rather, it is preferred that the fluid effluent from the desulfurization zone (comprising all the fluids exiting the desulfurization zone) comprises less than about 200 percent (by weight) of the amount of hydrogen sulfide in the fluid feed charged to the desulfurization zone (comprising all the fluids entering the desulfurization zone), more preferably less than about 150 percent of the amount of hydrogen sulfide in the fluid feed, and most preferably less hydrogen sulfide than the fluid feed.

The fluid effluent from the desulfurization zone preferably contains less than about 50 weight percent of the amount of sulfur in the fluid feed charged to the desulfurization zone, more preferably less than about 20 weight percent of the amount of sulfur in the fluid feed, and most preferably less than 5 weight percent of the amount of sulfur in the fluid feed. It is preferred for the total sulfur content of the fluid effluent from the desulfurization zone to be less than about 50 parts per million by weight (ppmw) of the total fluid effluent, more preferably less than about 30 ppmw, still more preferably less than about 15 ppmw, and most preferably less than 10 ppmw. The desulfurized fluid, preferably desulfurized cracked-gasoline or diesel fuel, can thereafter be recovered from the fluid effluent and preferably liquified. The liquification of such desulfurized fluid can be accomplished by any method or manner known in the art. The liquified, desulfurized fluid preferably comprises less than about 50 weight percent of the amount of sulfur in the sulfur-containing fluid charged to the desulfurization zone, more preferably less than about 20 weight percent of the amount of sulfur in the sulfur-containing fluid, and most preferably less than 5 weight percent of the amount of sulfur in the sulfur-containing fluid. The desulfurized fluid preferably comprises less than about 50 ppmw sulfur, more preferably less than about 30 ppmw sulfur, still more preferably less than about 15 ppmw sulfur, and most preferably less than 10 ppmw sulfur.

After sulfur removal in the desulfurization zone, the fluids in the reaction zone and the solids in the reaction zone can then be separated by any manner or method known in the art for separating a solid from a fluid, preferably a solid from a gas. Examples of suitable separating means for separating solids and gasses include, but are not limited to, cyclonic devices, settling chambers, impingement devices, filters, and combinations thereof.

After separation of the sulfurized sorbent from the fluid effluent of the reactor, the sulfurized sorbent is preferably regenerated in a regeneration zone by contacting the sulfurized sorbent composition with an oxygen-containing regeneration stream under suitable regeneration conditions. The regeneration is preferably carried out at a temperature in a range of from about 200° F. to about 1500° F., more preferably from about 500° F. to about 1200° F., and most preferably from 800° F. to 1100° F. The total pressure in the regeneration zone is preferably maintained in a range of from about 10 psig to about 1500 psig, more preferably in a range of from 15 psig to 100 psig. The residence time of the sorbent in the regeneration zone can be any time sufficient to achieve the desired level of sorbent regeneration. Such regeneration residence time is preferably in a range of from about 0.1 hours to about 24 hours, more preferably from 0.5 hours to 3 hours. These parameters provide for best sorbent regeneration.

The oxygen-containing regeneration stream employed in the regeneration step can be any oxygen-containing stream that, when contacted with the sulfurized sorbent composition under the above-described regeneration conditions, promotes the conversion of at least a portion of the zinc sulfide associated with desulfurized sorbent to zinc oxide, promotes the conversion of at least a portion of the substitutional solid metal solution (M_{A}Zn_{B}) and/or sulfided substitutional solid metal solution (M_{A}Zn_{B}S) to the substitutional solid metal oxide solution (M_{X}Zn_{Y}O) and burns off any remaining hydrocarbon deposits that might be present on the sulfurized sorbent composition.

In carrying out the process of the present invention, a stripper zone can be inserted before and/or after, preferably before, regenerating the sulfurized sorbent composition in the regeneration zone. Such stripper zone, preferably utilizing a stripping agent, will serve to remove a portion, preferably all, of any hydrocarbon(s) from the sulfurized sorbent composition. Such stripper zone can also serve to remove oxygen and ulfur dioxide from the system prior to introduction of the regenerated sorbent composition into the activation zone. Such stripping employs a set of conditions that includes a total pressure, temperature, and stripping agent partial pressure.

Preferably, the stripping, when employed, is carried out at a total pressure in a range of from about 25 pounds per square inch absolute (psia) to about 500 psia. The temperature for such stripping can be in a range of from about 100° F. to about 1000° F. Such stripping is carried out for a time sufficient to achieve the desired level of stripping. Such stripping can generally be achieved in a time period in a range of from about 0.1 hour to about 4 hours, preferably in a range of from about 0.3 hour to about 1 hour. The stripping agent is a composition(s) that helps remove a hydrocarbon(s) from a sulfurized sorbent composition. Preferably, the stripping agent is nitrogen.

After regeneration, and optionally stripping, the desulfurized sorbent composition is subjected to reduction (i.e., activation) in an activation zone under activation conditions with a reducing stream, preferably a hydrogen-containing reducing stream, so that at least a portion of the substitutional solid metal oxide solution (M_{X}Zn_{Y}O) is reduced to form the substitutional solid metal solution (M_{A}Zn_{B}) thereby providing a reduced sorbent composition comprising a reduced-alence promoter metal. Such substitutional solid metal solution (M_{A}Zn_{B}) is present in the sorbent composition in an amount which provides for the removal of sulfur from a sulfur-containing fluid according to the process of the present invention.

Typical activation conditions at which the activation zone is maintained includes a temperature in a range of from about 100° F. to about 1500° F., more preferably from about 500° F. to about 900° F., and most preferably from 600° F. to 800° F. The activation zone is preferably maintained at a pressure in a range of from about 10 psig to about 1500 psig, more preferably from 15 psig to 100 psig. The residence time of the sorbent in the activation zone is preferably in a range of from about 0.1 hours to about 40 hours, more preferably from about 0.2 hours to about 10 hours, and most preferably from about 0.5 hours to 1 hour. The reducing stream with which the regenerated sorbent is contacted in the activation zone preferably contains at least about 25 volume percent hydrogen, more preferably at least about 50 volume percent hydrogen, still more preferably at least about 90 volume percent hydrogen, and most preferably at least 95 volume percent hydrogen. It is not essential to the practice of the present invention that a high purity hydrogen be employed in achieving the desired reduction (i.e., activation) of the sorbent composition. Conditions recited in this paragraph provide for best activation of the desulfurized sorbent.

Once the sorbent has been activated in the activation zone, at least a portion of the activated sorbent can be returned to the desulfurization zone for further desulfurization of the sulfur-containing fluid.

When carrying out the process of the present invention, the steps of desulfurizing, regenerating, activating, and optionally stripping before and/or after regenerating, can be accomplished in a single zone or vessel or in multiple zones or vessels. The desulfurization zone can be any zone wherein desulfurizing of a sulfur-ontaining fluid, such as cracked-gasoline or diesel fuel, can take place. The regeneration zone can be any zone where regenerating of a sulfurized sorbent can take place. The activation zone can be any zone wherein reducing (i.e., activating) a regenerated, desulfurized sorbent can take place. Examples of suitable zones are fixed bed reactors, moving bed reactors, transport reactors, reactor vessels, and the like. When carrying out the process of the present invention in a fixed bed reactor, the steps of desulfurizing, regenerating, and activating, are accomplished in a single zone or vessel. When carrying out the process of the present invention in a fluidized bed reactor system, the steps of desulfurizing, regenerating, and reducing are accomplished in multiple zones or vessels.

The following examples are presented to further illustrate this invention and are not to be construed as unduly limiting the scope of this invention.

### EXAMPLE I

Sorbent A was prepared by combining 500 grams of distilled water and 60 grams of aluminum hydroxide powder (Dispal®0 Alumina Powder, available from CONDEA Vista Company, Houston, Tex.) in a Cowles Mixer. The mixer was turned on and 10 grams of concentrated nitric acid was slowly added to the alumina slurry during mixing. Mixing was continued for about 30 minutes until the alumina was dispersed in the mixture. While mixing continued, 150 grams of kaolin clay (ASP 600™, available from Engelhard Corporation, Iselin, N.J.) was added to the acid-containing alumina slurry, and mixing was thereafter continued for about 20 minutes to obtain a homogeneous mixture. A 55 gram quantity of concentrated nitric acid was then added to the mixer and mixed for about 10 minutes until homogeneous. A 118 gram quantity of zinc oxide powder (available from Zinc Corporation, Monaca, Pa.) was then added to the mixer and mixed for about 10 minutes until a homogeneous support mixture was produced. The resulting mixture was designated Support Mixture A. The pH of the Support Mixture A was 5.92.

Support Mixture A was then formed into microsphere particles using a counter-current spray dryer (Niro Atomizer Model 68, available from Niro Atomizer, Inc., Columbia, Mo.). In the spray dryer, the support mixture was passed through a 0.35 inch fountain head nozzle at about 43 cc/min into a particulation chamber. Air flowing through the particulation chamber at about 20 liters per minute (inlet temperature=320° C., outlet temperature=150° C.) dried the sprayed sorbent base mixture to thereby create support particles. The support particles were then placed in a muffle furnace for calcining in air by ramping the furnace temperature at 3° C./min from room temperature to 150° C. and holding at 150° C. for 1 hour, followed by ramping the temperature at 3° C./min to 635° C. and holding for 1 hour. The calcined support particles were then screened to remove particles less than 40 microns and more than 250 microns.

The screened support particles were then impregnated with 15 weight percent nickel (as the metal) using melted nickel nitrate hexahydrate in 5 weight percent water to get it to melt. Impregnation was accomplished by spraying the nickel solution-melt onto the support particles while the particles were rotated in a baffled cement mixer-type device. The once-impregnated sorbent (comprising about 15 wt % nickel) was then calcined in the same manner as described above. The calcined once-impregnated sorbent was then impregnated with an additional 15 weight percent nickel (as the metal) using the procedure described above. The twice-impregnated sorbent (comprising about 30 wt % nickel) was then calcined in the same manner as described above. The resulting sorbent was designated Sorbent A.

Sorbent B was prepared by combining 500 grams of distilled water and 60 grams of aluminum hydroxide powder (Dispal® Alumina Powder, available from CONDEA Vista Company, Houston, Tex.) in a Cowles Mixer. The mixer was then turned on and 5 grams of concentrated nitric acid was slowly added to the alumina slurry during mixing. Mixing was continued for about 30 minutes until the alumina was dispersed in the mixture. While mixing continued, 150 grams of kaolin clay (ASP 600™, available from Engelhard Corporation, Iselin, N.J.) was added to the acid-containing alumina slurry, and mixing was thereafter continued for about 20 minutes to obtain a homogeneous mixture. An additional 70 grams of concentrated nitric acid was added and stirring continued. 110 gram quantity of zinc oxide powder (available from Zinc Corporation, Monaca, Pa.) was then added to the mixer and mixed for about 10 minutes until a homogeneous support mixture was produced. This blend stayed more lquid longer than the blend of Sorbent A and was much easier to spray dry than the blend of Sorbent A. The resulting mixture was designated Support Mixture B. The pH of Support Mixture B was 5.84.

Support Mixture B was thereafter spray dried, calcined, and impregnated with about 30 weight percent nickel in the same manner described above with reference to Sorbent A. The resulting nickel-promoted sorbent was designated Sorbent B.

Sorbent C was a “scaled-up” version of Sorbent A, comprising larger quantities, but the same ratios, of the sorbent components employed in Sorbent A. Sorbent C was made by combining 6000 grams of distilled water and 720 grams of aluminum hydroxide powder (Dispal® Alumina Powder, available from CONDEA Vista Company, Houston, Tex.) in a Cowles Mixer. The mixer was turned on and 120 grams of concentrated nitric acid was slowly added to the alumina slurry during mixing. Mixing was continued for about 30 minutes until the alumina was dispersed in the mixture. While mixing, 1800 grams of kaolin clay (ASP 600™, available from Engelhard Corporation, Iselin, N.J.) was added to the acid-ontaining alumina slurry and mixing was thereafter continued for about 20 minutes until homogeneous. A 600 gram quantity of zinc oxide powder (available from Zinc Corporation, Monaca, Pa.) was then added to the mixer and mixed for about 10 minutes until homogeneous. While mixing, a 660 gram quantity of oncentrated nitric acid was slowly added to the mixer and mixed for about 10 minutes until homogeneous. An 816 gram quantity of zinc oxide powder (available from Zinc Corporation, Monaca, Pa.) was then added to the mixer while mixing. Thereafter, mixing was continued for about 10 minutes until a homogeneous sorbent base mixture was produced. The resulting mixture was designated Support Mixture C. The pH of Support Mixture C was not measured, but should have been about the same as the pH for Support Mixture A (i.e., 5.92) because Support Mixtures A and C contained the same components in the same ratios and were prepared by substantially the same process.

Support Mixture C was thereafter spray dried, calcined, and impregnated with about 30 weight percent nickel in the same manner described above with reference to Sorbent A. The resulting nickel-promoted sorbent was designated Sorbent C.

### EXAMPLE II

The attrition resistance of Sorbents A and B was determined using the Davison Test. The Davison Index, which represents the weight percent of the over 20 micrometer particle size fraction which is reduced to particle sizes of less than 20 micrometers under test conditions, was measured using a jet cup attrition determination method. The jet cup attrition determination involved screening a 5 gram sample of sorbent to remove particles in the 0 to 20 micrometer size range. The sorbent particles above 20 micrometers were then subjected to a tangential jet of air at a rate of 21 liters per minute introduced through a 0.0625 inch diameter orifice at the bottom of a specially designed jet cup (1″ I.D.×2″ height) for a period of 1 hour. The Davison Index (DI) was calculated as follows:

The correction factor of 0.3 was determined using a known calibration standard to adjust for differences in jet cup dimensions and wear.

Table 1 summarizes the Davison Index (DI) values for Sorbents A, B, and C.

TABLE 1

| | | Davison Index of Impregnated |
|---|---|---|
| Sorbent | pH of Support Mixture | Sorbent |
| A | 5.92 | 5.79 |
| B | 5.84 | 3.47 |
| C* | 5.92** | 5.79** |

*“Scaled-Up” version of Sorbent A
**Based on test of similarly-prepared Sorbent A

### EXAMPLE III

Sorbent C was tested for desulfurization activity by contacting it with a sulfur-containing gasoline in a micro fluidized bed reactor (1 inch quartz reactor chamber).

Prior to contacting with gasoline, Sorbent C was reduced at about 700° F. for about 30 minutes in hydrogen flowing through the reactor at about 350 cc/min. Following reduction, a co-feed gas containing about 150 cc/min H₂ and about 150 cc/min N₂ (i.e., 50:50 H₂:N₂ volume percent) was charged to the reactor and the gasoline feed was started at about 13.4 cc/hour. The gasoline charged to the reactor contained about 350 ppmw sulfur. The sulfur absorption cycle was continued for about four hours, and after each four hour cycle the sulfided sorbent was regenerated at about 900° F. for about two hours with a mixture of about 4% oxygen and the balance of nitrogen and then reduced at about 700° F. for about 30 minutes with H₂ flowing at about 300 cc/min. During each four hour absorption cycle, the condensed gasoline product was sampled hourly and tested for its sulfur content by x-ray fluorescence. The absorption/regeneration/reduction cycle, employing the 50:50 H₂:N₂ co-feed gas was continued for a total of 30 hours.

At 30 hours, the co-feed gas employed during absorption was changed from a 50:50 volume percent mixture of H₂ and N₂ to about 300 cc/min of pure hydrogen. The absorption/regeneration/reduction cycle, employing the 100% H₂ co-feed gas, was then continued for an additional 10 hours (40 total hours on stream).

At 40 hours on stream, the co-feed gas employed during absorption was changed from pure H₂ to a 90:10 volume percent mixture of H₂ and N₂. The absorption/regeneration/reduction cycle was then continued with the 90:10 H₂:N₂ co-feed gas for an additional three hours (43 total hours on stream).

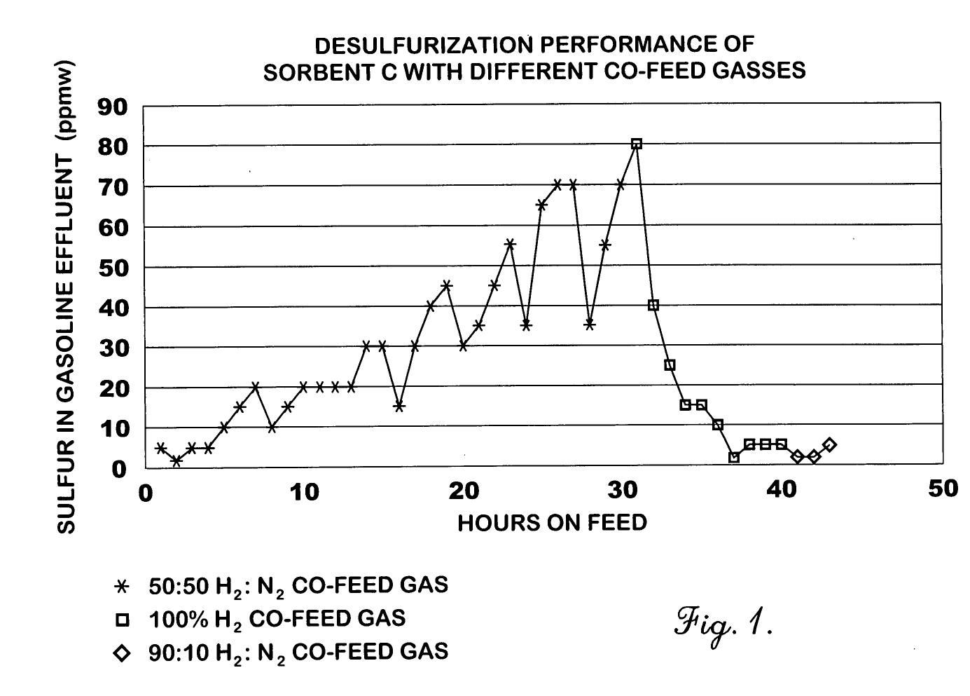

FIG. 1 shows the desulfurization activity of Sorbent C during the 43 hours on stream. During the first 30 hours on stream (i.e., when a 50:50 H₂:N₂ co-feed gas was employed) the desulfurization activity of Sorbent C consistently declined, as indicated by the increased sulfur content in the effluent from the reactor. However, between 30 and 40 hours on stream (i.e., when a pure H₂ co-feed gas was employed) the desulfurization activity of Sorbent C rapidly increased back to its initial activity. Between 40 and 43 hours on stream (i.e., when a 90:10 H₂:N₂ co-feed gas was employed) the desulfurization activity was maintained at or near its initial high activity. Thus, lower H₂ partial pressure in the co-feed gas tended to deactivate Sorbent C while high H₂ partial pressure in the co-feed gas tended to maintain the activity of, or even reactivate, Sorbent C.

Employing pure H₂ as the co-feed gas, however, had a downside. When pure H₂ was used as the co-feed gas, the RON, MON, and percent olefins loss, which were negligible when the 50:50 H₂:N₂ co-feed gas was used, were substantial with up to a six point RON loss, up to a two point MON loss, and up to 50 percent of the olefins being saturated. When the 90:10 H₂:N₂ lift gas was employed, however, RON, MON, and percent olefins loss were maintained at acceptable levels. Thus, although a low H₂ (e.g., 50:50 H₂:N₂) co-feed gas and a pure H₂ co-feed gas provided unacceptable results (due to either sorbent deactivation or feed dehydrogenation), a slightly less than pure (e.g., 90:10 H₂:N₂) H₂ co-feed gas provided for optimum activity and minimal dehydrogenation.

### EXAMPLE IV

Sorbent D was prepared by combining 672.7 grams of distilled water and 72.88 grams of aluminum hydroxide powder (Dispal® Alumina Powder, available from CONDEA Vista Company, Houston, Tex.) in a Cowles mixer. The mixer was turned on to mix the water and alumina for about 20 minutes. In a separate container, 87.4 grams of expanded perlite (available from World Minerals, Inc., Lompoc, Calif.) and 274.72 grams of powdered zinc oxide (available from Zinc Corporation, Monaca, Pa.) were mixed. Over a 5 minute period, the perlite/zinc oxide mixture was added to the alumina slurry while mixing of the alumina slurry was continued. The combined support mixture was then mixed for about 10 minutes until a homogeneous support mixture was produced. The resulting mixture was designated support mixture D.

Support mixture D was then formed into microsphere particles by spray-dying in substantially the same manner as described above with reference to support mixture A. The spray-dried support particles were then dried and calcined in the same manner as described above with reference to support mixture A.

The calcined support particles were then impregnated with about 16 weight percent nickel (as the metal) using melted nickel nitrate hexahydrate in 5 weight percent water. Impregnation was accomplished by spraying the nickel solution-melt onto the support particles while the particles were rotated in a baffled cement mixer-type device. The impregnated sorbent (comprising about 16 weight percent nickel) was then dried and calcined in the same manner as described above with reference to sorbent A. The resulting sorbent was designated sorbent D.

Sorbent E was prepared by combining 600.7 grams of distilled water and 72.9 grams of aluminum hydroxide powder (Dispal® Alumina Powder, available from CONDEA Vista Company, Houston, Tex.) in a Cowles mixer to create an alumina slurry. The alumina slurry was mixed in the mixer for about 20 minutes. In a separate mixer, 87.4 grams of expanded perlite (available from World Minerals, Inc., Lompoc, Calif.) and 274.7 grams of powdered zinc oxide (available from Zinc Corporation, Monaca, Pa.) were mixed. Over a 5 minute period, the perlite/zinc oxide mixture was added to the alumina slurry while mixing. The combined slurry was then mixed for a period of about 10 minutes. While mixing the combined slurry, 4.9 grams of concentrated nitric acid (HNO₃) was added to the mixture to reduce the pH of the support mixture from 6.84 to 6.32. An additional 72 grams of distilled water and an additional 0.5 grams of concentrated nitric acid (HNO₃) were then added to the pH-reduced support slurry and mixed for 10 minutes. The resulting mixture had a pH of 6.34 and was designated support mixture E.

Support mixture E was then spray-dried, dried, calcined, impregnated, dried, and calcined in the same manner described above with reference to sorbent D, to thereby provide a sorbent comprising about 16 weight percent nickel. The resulting sorbent was designated sorbent E.

### EXAMPLE V

The attrition resistence of sorbents D and E was determined using the Davison Test, described above in Example II. Table 2 summarizes the Davison Index values for sorbents D and E.

TABLE 2

| | HNO₃ Added to Support Mixture | Davison Index of Impregnated |
|---|---|---|
| Sorbent | (g) | Sorbent |
| D | 0 | 18.8 |
| E | 5.4 | 16.3 |

Table 2 illustrates that when an acid is employed to lower the pH of the support mixture, the attrition resistance of the resulting sorbent composition is enhanced.

Reasonable variations, modifications, and adaptations may be made within the scope of this disclosure and the appended claims without departing from the scope of this invention.

1. A process for making a sorbent composition, said process comprising the steps of:
(a) admixing a zinc source and an aluminum source to provide a support mixture;
(b) controlling the pH of said support mixture in a range of from about 5.0 to about 7.0; and
(c) incorporating a promoter metal with said support mixture to provide promoted sorbent.

2. A process according to claim 1, wherein the pH of said support mixture is controlled in step (b) in a range of from about 5.5 to about 6.5.

3. A process according to claim 1, wherein the pH of said support mixture is controlled in step (b) in a range of from 5.7 to 6.0.

4. A process according to claim 1, further including the step of:
(d) shaping said support mixture into support particulates.

5. A process according to claim 4, wherein said shaping in step (d) is performed by spray drying.

6. A process according to claim 5, wherein said support particulates are in the form of microspheres having a diameter in a range of from about 1 to about 500 microns.

7. A process according to claim 4, further including the step of:
(e) calcining said support particulates to thereby provide calcined support particulates having a zinc aluminate component formed from at least a portion of said zinc source and at least a portion of said aluminum source.

8. A process according to claim 1, further including the step of:
(f) calcining said promoted sorbent to thereby provide a calcined promoted support having a substitutional solid metal oxide solution component characterized by the formula: M_{X}Zn_{Y}O, wherein M is said promoter metal, X is a numerical value in a range of from about 0.5 to about 0.9, and Y is a numerical value in a range of from about 0.1 to about 0.5.

9. A process according to claim 8, further including the step of:
(g) reducing said calcined promoted sorbent to thereby reduce at least a portion of said substitutional solid metal oxide solution component and to thereby provide a reduced sorbent.

10. A process according to claim 9, wherein said reduced sorbent comprises a substitutional solid metal solution component characterized by the formula: M_{A}Zn_{B}, wherein M is said promoter metal, A is a numerical value in a range of from about 0.50 to about 0.99, and B is a numerical value in a range of from about 0.01 to about 0.50.

11. A process according to claim 10, wherein said promoter metal is selected from the group consisting of nickel, cobalt, iron, manganese, tungsten, silver, gold, copper, platinum, zinc, tin, ruthenium, molybdenum, antimony, vanadium, iridium, chromium, and palladium.

12. A process according to claim 10, wherein said promoter metal is nickel.

13. A process according to claim 1, wherein said zinc source comprises zinc oxide and said aluminum source comprises alumina.

14. A process according to claim 1, wherein step (a) includes the step of combining a filler with the zinc source and the aluminum source to provide said support mixture, wherein said filler is operable to enhance the spray-dry ability of said support mixture.

15. A process according to claim 14, wherein said filler comprises a kaolin clay.

16. A process according to claim 1, wherein step (a) includes the step of combining a porosity enhancer with said zinc source and said aluminum source to provide said support mixture, wherein said porosity enhancer is operable to enhance the macroporosity of said promoted sorbent.

17. A process according to claim 16, wherein said porosity enhancer comprises perlite.

18. A process for making a sorbent composition, said process comprising the steps of:
(a) admixing a zinc source, an aluminum source, and an acid to provide a support mixture, wherein said acid is present in said support mixture in an amount sufficient to maintain the pH of said support mixture in a range of from about 5.0 to about 7.0;
(b) shaping said support mixture into support particulates;
(c) calcining said support particulates to provide calcined support particulates comprising a zinc aluminate component;
(d) incorporating a promoter metal with said calcined support particulates to provide a promoted sorbent;
(e) calcining said promoted sorbent to provide a calcined promoted sorbent; and
(f) reducing said calcined promoted sorbent to thereby provide a reduced sorbent.

19. A process according to claim 18, wherein said acid is present in said support mixture in an amount sufficient to maintain the pH of said support mixture in a range of from about 5.5 to about 6.5.

20. A process according to claim 18, wherein said acid is present in said support mixture in an amount sufficient to maintain the pH of said support mixture in a range of from 5.7 to 6.0.

21. A process according to claim 18, wherein the weight ratio of said zinc source to said aluminum source in said support mixture is from about 1:1 to about 20:1, and the weight ratio of said zinc source to said acid is from about 0.5:1 to about 10:1.

22. A process according to claim 21, wherein said zinc source comprises a powdered zinc oxide, said aluminum source comprises a hydrated alumina, and said promoter metal comprises nickel.

23. A process according to claim 22, wherein said acid comprises concentrated nitric acid.

24. A process according to claim 23, wherein step (a) includes combining kaolin clay or perlite with said zinc source, said aluminum source, and said acid to provide said support mixture.

25. A process according to claim 18, wherein said calcined promoted sorbent has a Davison Index value of less than about 20.

26. A process according to claim 18, wherein said calcined promoted sorbent has a Davison Index value of less than about 10.

27. A process according to claim 18, wherein step (a) includes the step of mixing said support mixture until said support mixture is at least substantially homogeneous.

28. (cancel)

29. (cancel)

30. (cancel)

31. (cancel)

32. (cancel)

33. (cancel)

34. (cancel)

35. (cancel)

36. (cancel)

37. (cancel)

38. (cancel)

39. (cancel)

28. A sorbent composition made by the process of claim 1.

29. A sorbent composition made by the process of claim 18.
